(19) United States
(12) Patent Application Publication
(10) Pub. No.: US 2002/0155320 A1
(43) Pub. Date: Oct. 24, 2002

(54) Organic electroluminescent device

(75) Inventors: Jae Yong Park, Kyounggi-do (KR); Ock Hee Kim, Kyounggi-do (KR); Kwan Soo Kim, Kyounggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/125,642

(22) Filed: Apr. 19, 2002

(30) Foreign Application Priority Data
Apr. 20, 2001 (KR) P2001-21293
Jun. 25, 2001 (KR) P2001-36210

(51) Int. Cl. H05B 33/04

(52) U.S. Cl. 428/690; 428/917; 428/68; 428/156; 313/512; 257/99; 257/100

(57) ABSTRACT

An organic electroluminescent device includes a substrate, an organic electroluminescent portion, and a packaging plate. The organic electroluminescent portion is formed on the substrate, and the packaging plate is joined with the substrate to cover the organic electroluminescent portion. A sealant is disposed between the substrate and the packaging plate to join the substrate with the packaging plate. The organic electroluminescent device may include a diffusion preventing portion disposed on at least one of the packaging plate and the substrate to prevent the sealant from contacting the organic electroluminescent portion. The organic electroluminescent may include a moisture absorbent film disposed on at least one of the substrate, the packaging plate, and the organic electroluminescent layer.

The present invention claims the benefit of Korean Patent Application No. P2001-21293 filed in Korea on Apr. 20, 2001 and of Korean Patent Application No. P2001-36210 filed in Korea on Jun. 25, 2001, which are both hereby incorporated by reference.

### BACKGROUND OF THE INVENTION

1. Field of the Invention

This invention relates to an organic electroluminescent device, and more particularly, to an organic electroluminescent device that is capable of preventing an adhesive from being spread to a luminescent area.

2. Discussion of the Related Art

Recently, there have been developed various flat panel display devices with reduced weight and size capable of overcoming disadvantages of cathode ray tube (CRT) devices. Such flat panel display devices include liquid crystal display (LCD) devices, a field emission display (FED) devices, a plasma display panel (PDP) devices, and an electroluminescent (EL) devices, etc.

Research has been conducted to improve display quality of flat panel display devices and to provide flat panel displays with large-scale screens. Compared with a photo-detecting device like the LCD that is currently used in many applications, the EL display has an advantage in that its response speed is as fast as that of a cathode ray tube. Because a low direct current driving voltage and an ultra thin film are possible in the EL display, an EL device can be sufficiently thin to be applied in a wall hanging appliance or a portable appliance. Such EL display devices are generally classified according to its material as inorganic EL displays or an organic EL displays. An EL display is a self-luminescent device that emits light by itself. The EL display excites a fluorescent material by use of electric charge such as electrons, holes and so on to display a picture or video image. The EL display is excellent in luminescent efficiency, brightness and viewing angle. However, EL display is easily degraded by moisture and oxygen.

To solve such a problem, the EL display has a packaging plate adhere to it for an encapsulation as in FIG. 1. Referring to FIG. 1, a conventional EL display device includes a substrate 2, an EL structure 10 formed on the substrate 2 for emitting light in accordance with a driving voltage supplied, and a packaging plate 20 combined with the substrate 2 by an adhesive 18 and adhered to it in the manner of covering the EL structure 10.

The EL structure 10 has a first electrode 6 and a second electrode 4 formed on the substrate 2. In addition, an organic compound layer 8 is deposited between the first electrode 6 and the second electrode 4. At least one of the first electrode 6 and the second electrode 4 should be transparent to radiate the emitted light to the outside of the device. The organic compound layer 8 may include a single or multi layer thin film structure that transfers electrons and holes supplied from the first electrode 6 and the second electrode 4. The electrons and holes are recombined to generate excitons thereafter emitting light. Therefore, the EL structure 10 emits light by having the electrons and the holes supplied from the first electrode 6 and the second electrode 4 to the organic compound layer 8.

A packaging plate 20 covers the first electrode 6, the second electrode 4 and the organic compound layer 8 formed on the substrate 2 to prevent the EL structure 10 from being degraded by moisture and oxygen in the atmosphere. The packaging plate 20 is adhered to the substrate 2 by an adhesive 18. Inert gas is injected into the space formed by joining the substrate 2 to the packaging plate 20. Accordingly, the packaging plate 20 should emit the heat generated upon the light-emission of the EL device and protects the EL structure 10 from external forces as well as moisture and oxygen in the atmosphere.

The packaging plate 20 includes a recess portion 12 formed at the center to contain a moisture absorbent 16. A semi-permeable membrane 14 supports the moisture absorbent 16. In one configuration, the recess portion 12 is formed by having a flat plate convexly bent at the area where it faces the EL structure 10 to contain the moisture absorbent 16. Material such as BaO, CaO or the like is disposed in the internal space of the concave portion 12 to absorb moisture and/or oxygen. Because the moisture absorbent 16 is a powder, the semi-permeable membrane 14 is adhered to the rear of the recess portion 12 to pass moisture and oxygen to but prevent the moisture absorbent 16 from falling onto the EL structure 10. Material such as Teflon, polyester, paper or the like may used as the semi-permeable membrane 14.

The substrate 2 having the EL structure 10 and the packaging plate 20 are joined together and sealed using the adhesive 18. The adhesive 18 may be formed of any material such as epoxy, ultraviolet-setting resin, low melting metal or the like. After being spread on the edge of the packaging plate 20, the adhesive 18 binds the substrate 2 to the packaging plate 20 by a fixed pressure under an inert gas atmosphere. At this time, the adhesive 18 spreads in accordance with the pressure that pushes down the packaging plate 20 and the quantity and viscosity of the spread adhesive, as shown in FIG. 2. Accordingly, the adhesive 18 can be diffused into the EL structure 10 to contact the organic compound layer 8 or to spread over to an undesired area. If the material of the adhesive 18 contacts the organic compound layer 8, they cause a reciprocal reaction to degrade the organic compound layer 8, thereby disrupting function.

As described, the packaging plate 20 is sealed with the substrate 2 in an inert gas atmosphere using the adhesive 18. As a result, heat generated by the luminescence of the EL structure 10 can be dissipated while preventing degradation by moisture and oxygen. However, there are still problems. For example, when a metal plate is used for the packaging plate 20, if the area is bigger, it also becomes more difficult to keep the metal plate flat and the weight increases since the metal plate should be thicker for flatness. Moreover, the adhesive 18 used for joining the packaging plate 20 to the substrate 2 less adhesive strength when applied to a metal plate. Further, when disposing the moisture absorbent in a powder type, the powder may drop onto an unwanted area, thereby affecting the device. Still further, it requires a semi-permeable membrane for supporting the moisture absorbent to absorb oxygen and moisture.

Referring to FIG. 3, another structure of a conventional EL device includes a substrate 22, an EL structure 30 formed on the substrate 22, and a packaging plate 40 having a flat shape adhered to the substrate 22 by an adhesive 38 to cover the EL structure 30. The EL structure 30 includes a first electrode 26 and a second electrode 24 formed on the substrate 22, and an organic compound layer 28 deposited between the first electrode 26 and the second electrode 24. At least one electrode between the first electrode 26 and the second electrode 24 should be transparent to radiate the emitted light to the outside. The organic compound layer 28 may be formed of a single or multi layer thin film that transfers electrons and holes supplied from the first electrode 26 and the second electrode 24. The electrons and holes are then recombined to generate excitons and thereafter emit light.

The packaging plate 40 is made of a flat glass plate. The packaging plate 40 includes a recess portion 32 for containing a absorbent 36 to absorb moisture, oxygen or the like. A semi-permeable membrane 34 supports the absorbent 36. The packaging plate 40 emits the heat generated upon the light-emission of the EL structure 30 and protects the EL structure 30 from external forces as well as moisture and oxygen in the atmosphere.

The recess portion 32 is formed on an inside surface of the packaging plate 40 that has been cut by a process such as etching, sand blasting or the like to contain the absorbent 36. The absorbent 36, such as BaO or CaO, is contained in the internal space of the recess portion 32 for absorbing moisture and oxygen. Because the absorbent 36 is a powder, the semi-permeable membrane 34 is adhered to the rear of the groove 32 to pass moisture and oxygen while preventing the absorbent 36 from falling onto the EL structure 30. Material such as Teflon, polyester, paper or the like may be used as the semi-permeable membrane 34.

The substrate 22 where the EL structure 30 is formed and the packaging plate 40 are joined together and sealed using an adhesive 38. The adhesive 38 is formed of a material such as epoxy, ultraviolet-setting resin, and low melting metal. After being spread on the edge of the packaging plate 40, the adhesive 38 binds the substrate 22 to the packaging plate 40 by a fixed pressure under an inert gas atmosphere. At this time, the adhesive 38 spreads in accordance with the pressure that pushes down the packaging plate 40, and the quantity and viscosity of the spread adhesive as shown in FIG. 4. Accordingly, the adhesive 38 can be diffused into the EL structure 30 to contact the organic compound layer 28 or to spread over to an undesired area. If the material of the adhesive 38 contacts the organic compound layer 28, they cause a reciprocal reaction to degrade the organic compound layer 28, thereby disrupting function.

As described, the packaging plate 40 is sealed with the substrate 22 in an inert gas atmosphere using the adhesive 38. As a result, heat generated by the luminescence of the EL structure 30 while preventing degradation by moisture and oxygen. However, there are still problems. For example, when a glass plate is used for the packaging plate 40, it includes a recess portion etched into the glass. Hence, there is a disadvantage that the cost of the glass to be used increases. Further, since there is a limit in the depth that be cut due to the mechanical intensity of the glass. As a result, to mount a sufficient amount of absorbent, a thick glass is used. Accordingly, weight and overall thickness is increased. Moreover, the absorbent is a powder and, therefore, can affect elements by falling on unwanted parts. In addition the semi-permeable membrane is inevitably required to support the absorbent for absorbing oxygen and moisture.

### SUMMARY OF THE INVENTION

Accordingly, the present invention is directed to an organic electroluminescent device that substantially obviates one or more problems due to limitations of the related art.

An object of the present invention is to provide an organic electroluminescent device that is capable of preventing an adhesive from spreading into a uminescent area.

Another object of the invention is to provide an organic electroluminescent device that can simplity a packaging plate and is suitable for an organic electro-luminescence with a large-scale screen.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the electroluminescent device includes an organic electroluminescent device comprises a substrate; an organic electroluminescent portion formed on the substrate; a packaging plate joined with the substrate to cover the organic electroluminescent portion; a sealant disposed between the substrate and the packaging plate to join the substrate with the packaging plate; and a diffusion preventing portion disposed on at least one of the packaging plate and the substrate to prevent the sealant from contacting the organic electroluminescent portion.

In another aspect, an organic electroluminescent device comprises a substrate; an organic electroluminescent portion formed on the substrate; a packaging plate to protect the organic electroluminescent portion from moisture and oxygen and from external forces; a moisture absorbent film disposed on at least one of the substrate, the packaging plate, and the organic electroluminescent layer; and a sealant disposed between the substrate and the packaging plate to join the substrate with the packaging plate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a sectional view showing a conventional organic electroluminescent device;

FIG. 2 is a sectional view showing an adhesive as shown in FIG. 1 being diffused to a luminescent area;

FIG. 3 is a sectional view showing another conventional electroluminescent device;

FIG. 4 is a sectional view showing an adhesive as shown in FIG. 3 being diffused to a luminescent area;

FIG. 5 is a sectional view showing an organic electroluminescent device according to a first embodiment of the present invention;

FIG. 6 is a plane view showing a packaging plate as illustrated in FIG. 5;

FIG. 7 is a sectional view showing that an adhesive as shown in FIG. 5 is prevented from being diffused to a luminescent area;

FIG. 8 is a sectional view showing an organic electroluminescent device according to another embodiment of the present invention;

FIG. 9 is a sectional view showing that an adhesive as shown in FIG. 8 is prevented from being diffused to a luminescent area;

FIG. 10 is a sectional view showing an organic electroluminescent device according to another embodiment of the present invention;

FIG. 11 is a sectional view showing that an adhesive as shown in FIG. 10 is prevented from being diffused to a luminescent area;

FIG. 12 is a sectional view showing an organic electroluminescent device according to another embodiment of the present invention;

FIG. 13 is a sectional view showing that an adhesive as shown in FIG. 12 is prevented from being diffused to a luminescent area;

FIG. 14 is a sectional view representing a projected portion formed on a substrate for preventing diffusion according to another embodiment of the present invention;

FIG. 15 is a sectional view representing a groove formed on a substrate for preventing diffusion according to another embodiment of the present invention;

FIG. 16 is a sectional view representing a projected portion formed on each of a substrate and a packaging plate for preventing diffusion according to another embodiment of the present invention;

FIG. 17 is a sectional view representing a groove formed on each of a substrate and a packaging plate for preventing diffusion according to another embodiment of the present invention;

FIG. 18 is a sectional view showing an organic electroluminescent device according to another embodiment of the present invention;

FIG. 19 is a sectional view showing an organic electroluminescent device according to another embodiment of the present invention;

FIG. 20 is a sectional view showing an organic electroluminescent device according to another embodiment of the present invention; and

FIG. 21 is a sectional view showing an organic electroluminescent device according to another embodiment of the present invention.

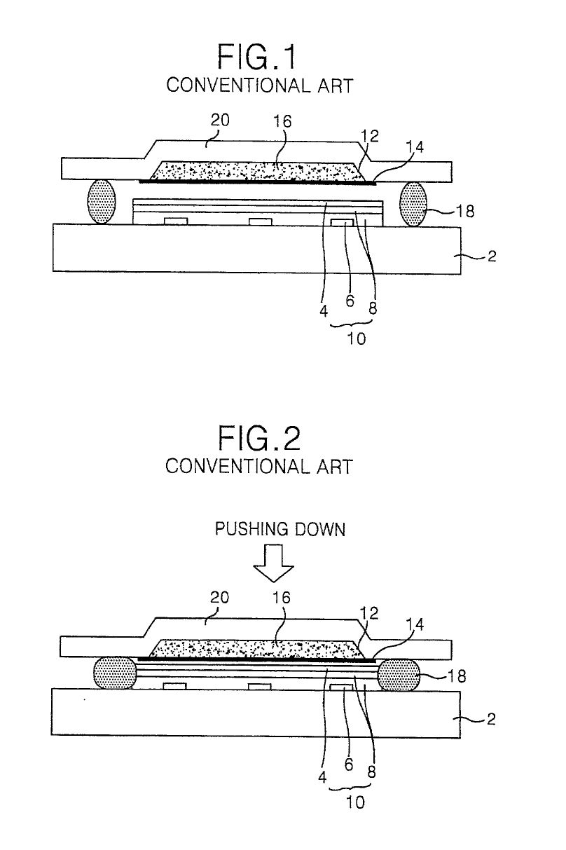

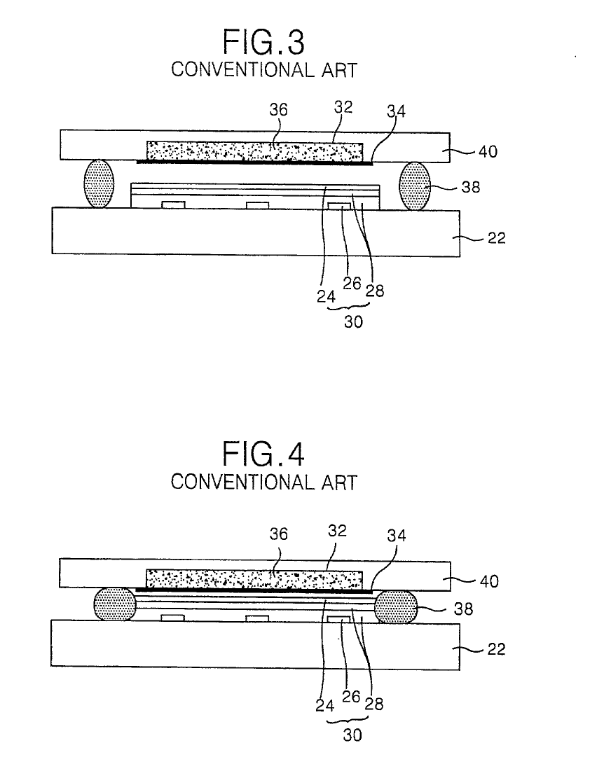

### DETAILED DESCRIPTION OF THE PREFERRED EMBODIMENTS

Reference will now be made in detail to the preferred embodiments of the present invention, examples of which are illustrated in the accompanying drawings.

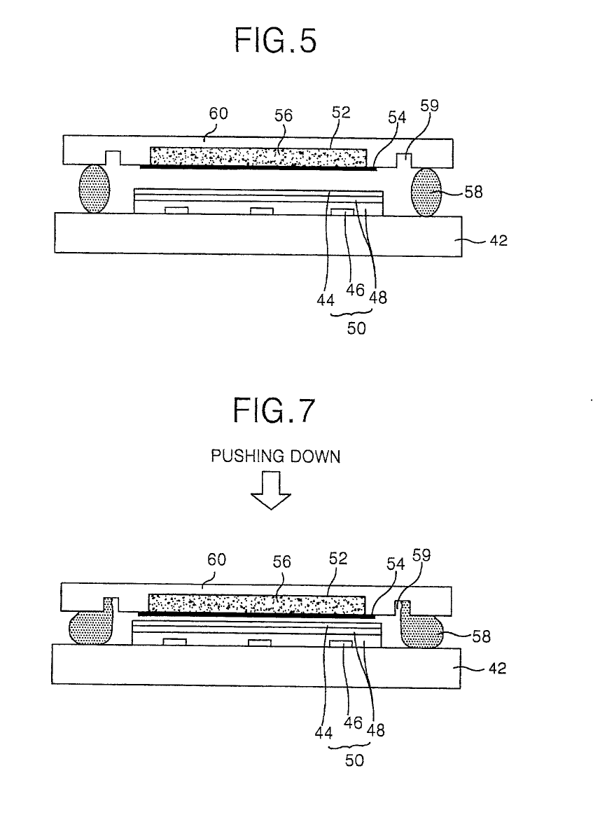

Referring to FIG. 5, an organic electroluminescent device according to a first embodiment of the present invention includes a substrate 42, an EL structure 50 formed on the substrate 42 and emitting light in accordance with a driving voltage and electric current supplied, a packaging plate 60 adhered to the substrate 42 by an adhesive 58 to cover an EL structure 50 and in which a diffusion preventing groove 59 is formed for preventing the adhesive 58 from being diffused.

The EL structure 50 includes a first electrode 46, and a second electrode 44 formed on the substrate 42. An organic compound layer 48 is deposited between the first electrode 46 and the second electrode 44. At least one of the first electrode 46 and the second electrode 44 should be transparent to radiate the emitted light to the outside. The organic compound layer 48 includes a single or multi layer thin film that transfers electrons and holes supplied from the first electrode 46 and the second electrode 44. The electrons and holes are recombined to generate excitons and thereafter to emit light.

The packaging plate 60 includes a groove 52 for containing an absorbent 56 to absorb moisture, oxygen or the like, a semi-permeable membrane 54 for supporting the moisture absorbent 56, and a diffusion preventing groove 59 for preventing the diffusion of the adhesive 58. The packaging plate 60 is made of material, such as glass, as a flat plate. The packaging plate 60 emits the heat generated by the light-emission of the EL structure 50 and protects the EL structure 50 from an external force as well as moisture and oxygen in the atmosphere.

The recess portion 52 may be formed in the packaging plate 60 by a cutting process such as etching, sand blasting or the like to contain the absorbent 56. The absorbent 56, such as BaO or CaO, is disposed in the internal space of the groove 52 for absorbing moisture and/or oxygen. Because the absorbent 56 is a powder, the semi-permeable membrane 54 is adhered to the rear of the recess portion 52 so that moisture and oxygen can pass but prevent the absorbent 56 from falling onto the EL structure 50. Material such as Teflon, polyester, paper or the like may be used as the semi-permeable membrane 54. Because of the absorbent material 56 and the semi-permeable membrane 54, light is preferably transmitted through the substrate 42.

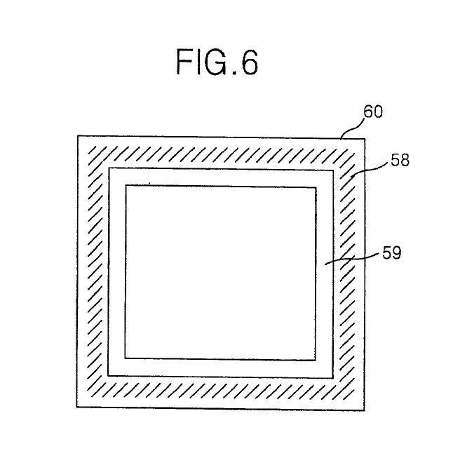

The diffusion preventing groove 59 is formed with a fixed width and depth between the center of packaging plate 60 and the adhesive 58 as shown in FIG. 6. The diffusion preventing groove 59 prevents the adhesive 58 from being diffused to the EL structure 50 while combining the substrate 42 and the packaging plate 60.

As shown in FIG. 7, the substrate 42 and the packaging plate 60 are combined together and sealed using an adhesive 58. For this, the adhesive 58 is preferably formed of one of a thermosetting resin, an ultraviolet-setting resin, low melting metal or the like. Such an adhesive 58, after being spread on the edge of the packaging plate 60, adheres the substrate 42 to the packaging plate 60 by a fixed pressure under an inert gas atmosphere. The adhesive 58 spreads in accordance with the pressure pushing down upon the packaging plate 60, as well as the quantity and viscosity of the spread adhesive. The adhesive 58 diffused toward the EL structure 50 is prevented from diffusing beyond the diffusion preventing groove 59. Accordingly, because the diffusion preventing groove 59 prevents the adhesive 58 from being diffused to the EL structure 50, degradation of the EL structure 50 is prevented.

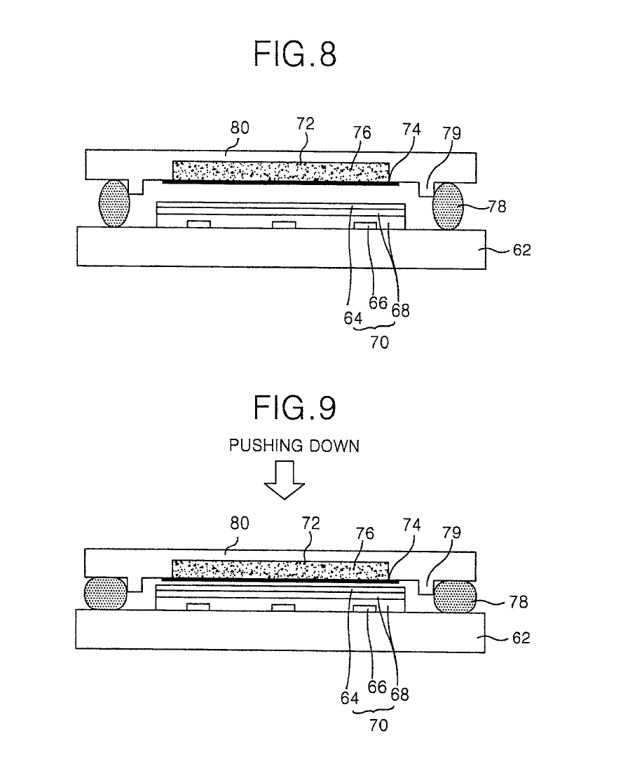

Referring to FIG. 8, an organic electroluminescent device according to a second embodiment of the present invention includes a substrate 62, an EL structure 70 formed on the substrate 62 and emitting light in accordance with a driving voltage and electric current supplied, and a packaging plate 80 adhered to the substrate 62 by an adhesive 78 in the manner of covering an EL structure 70 and having a diffusion preventing projected portion 79 is formed for preventing the adhesive 78 from being diffused. The EL structure 70 includes a first electrode 66 and a second electrode 64 formed on the substrate 62, as well as an organic compound layer 68 deposited between the first electrode 66 and the second electrode 64. At least one of the first electrode 66 and the second electrode 64 should be transparent to transmit the emitted light to the outside. The organic compound layer 68 may include a single or multi layer thin film structure that transfers electrons and holes supplied from the first electrode 66 and the second electrode 64. The electrons and holes are recombined to generate excitons and thereafter to emit light.

The packaging plate 80 includes a recess portion 72 for containing an absorbent 76 to absorb moisture, oxygen or the like, a semi-permeable membrane 74 for supporting the moisture absorbent 76, and a diffusion preventing projected portion 79 for preventing diffusion of the adhesive 78. The packaging plate 80 may be made of material such as glass in flat plate. The packaging plate 80 emits the heat generated upon the light-emission of the EL structure 70 and protects the EL structure 70 from external forces as well as moisture and oxygen in the atmosphere.

The recess portion 72 is formed in the substrate 62 by a cutting process such as etching, sand blasting or the like for containing the absorbent 76. The absorbent 76, such as BaO or CaO, is contained in the internal space of the groove recess portion 72 for absorbing moisture and/or oxygen. Because the absorbent 76 is a powder, the semi-permeable membrane 74 is adhered to the rear of the groove 72 to pass moisture and oxygen but to prevent the absorbent 76 from falling onto the EL structure 70. Material such as Teflon, polyester, paper or etc is used as the semi-permeable membrane 74.

The diffusion preventing projected portion 79 is formed with a fixed width between the center of packaging plate 80 and the adhesive 78. The diffusion preventing projected portion 79 prevents the adhesive 78 from being diffused to the EL structure 70 when combining the substrate 62 and the packaging plate 80.

As shown in FIG. 9, the substrate 62 and the packaging plate 80 are combined together by sealing them with an adhesive 78. For this, the adhesive 78 may be formed of a material such as thermosetting resin, ultraviolet-setting resin, low melting metal or the like. The adhesive 78 spreads in accordance with the pressure pushing down the packaging plate 80 as well as the quantity and viscosity of the spread adhesive, and it is important to control the degree of the spread. Even though there is a process deviation, the diffusion preventing projected portion 79 prevents the adhensive 78 from diffusing beyond a fixed area. Thus, the adhesive 78 diffused to the EL structure 70 by the pressure is prevented by the diffusion preventing projected portion 79. Accordingly, because the diffusion preventing projected portion 79 prevents the adhesive 78 from being diffused to the EL structure 70, degradation of the EL structure 70 is prevented.

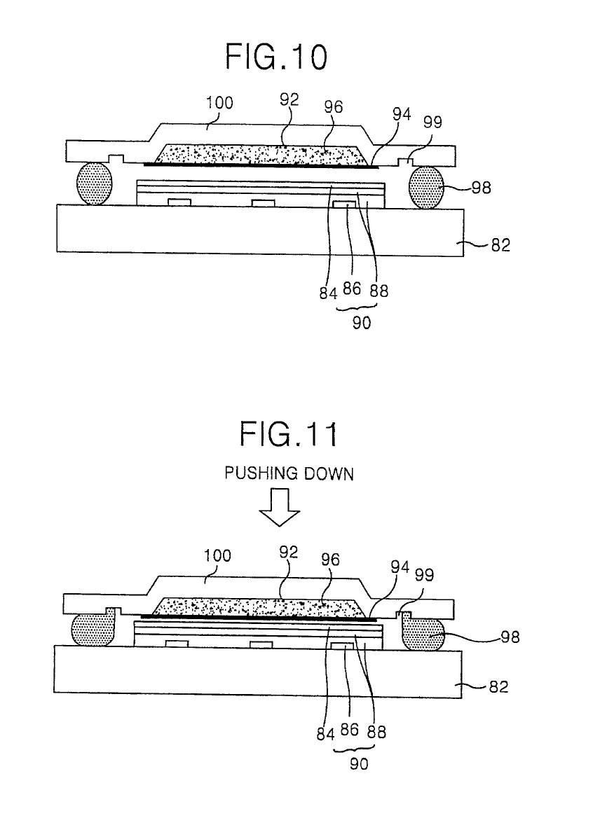

Referring to FIG. 10, an organic electroluminescent device according to a third embodiment of the present invention includes a substrate 82, an EL structure 90 formed on the substrate 82 and emitting light in accordance with a driving voltage and electric current supplied, and a packaging plate 100 adhered to the substrate 82 by an adhesive 98 to cover an EL structure 90 and having a diffusion preventing groove 99 for preventing the adhesive 98 from being diffused.

The EL structure 90 includes a first electrode 86 and a second electrode 84 formed on the substrate 82, and an organic compound layer 88 deposited between the first electrode 86 and the second electrode 84. At least one of the first electrode 86 and the second electrode 84 should be transparent to radiate the emitted light to the outside.

The organic compound layer 88 includes a single and multi layer thin film that transfers electrons and holes supplied from the first electrode 86 and the second electrode 84, or recombines them to generate excitons and to emit light. In this way, electrons and holes are supplied from the first electrode 86 and the second electrode 84 to the organic compound layer 88 and are recombined such that the EL structure 90 emits light.

The packaging plate 100 covers the first electrode 86, the second electrode 84 and the organic compound layer 88 formed on the substrate 82 for preventing the EL structure 90 from being easily degraded by moisture and/or oxygen in the atmosphere. Inert gas is injected into the space formed by joining the substrate 82 to the packaging plate 100. An adhesive 98 adheres the packaging plate 100 to the substrate 82. The packaging plate 100 emits the heat generated by the light-emission of the EL display and protects the EL structure 90 from external forces as well as moisture and oxygen in the atmosphere.

For this, the packaging plate 100 includes a recess portion 92 formed at the central portion for containing an absorbent 96, a semi-permeable membrane 94 for supporting the moisture absorbent 96, and a diffusion preventing groove 99 for preventing the diffusion of the adhesive 98.

The recess portion 92 is formed by convexly bending a flat plate at the area where it faces the EL structure 90 for containing the absorbent 96. Material, such as BaO or CaO, is contained in the internal space of the recess portion 92 for absorbing moisture and/or oxygen. Because the moisture absorbent 96 is powder, the semi-permeable membrane 94 is adhered at the recess portion 92 to pass moisture and oxygen, but prevents the absorbent 96 from falling onto the EL structure 90. Material such as Teflon, polyester, paper or the like is used as the semi-permeable membrane 94.

The diffusion preventing groove 99 is formed with a fixed width and depth within the area where the adhesive 98 is spread along the edge of the packaging plate 100. The diffusion preventing groove 99 prevents the adhesive 98 from being diffused to the EL structure 90 when combining the substrate 82 and the packaging plate 100.

As shown in FIG. 11, the substrate 82 and the packaging plate 100 are combined and sealed using the adhesive 98. For this, the adhesive 98 may be formed of a material such as thermosetting resin, ultraviolet-setting resin, low melting metal or the like. After being spread along the edge of the packaging plate 100 with a fixed width, the adhesive 98 adheres the substrate 82 to the packaging plate 100 by a fixed pressure in an inert gas atmosphere. The adhesive 98 becomes spread in accordance with the pressure pushing down upon the packaging plate 100, and the quantity and viscosity of the spread adhesive. The adhesive 98 diffused toward the EL structure 90 is prevented from diffusing beyond the diffusion preventing groove 99. Accordingly, because the diffusion preventing groove 99 prevents the adhesive 98 from being diffused to the EL structure 90, degradation of the EL structure 90 is prevented.

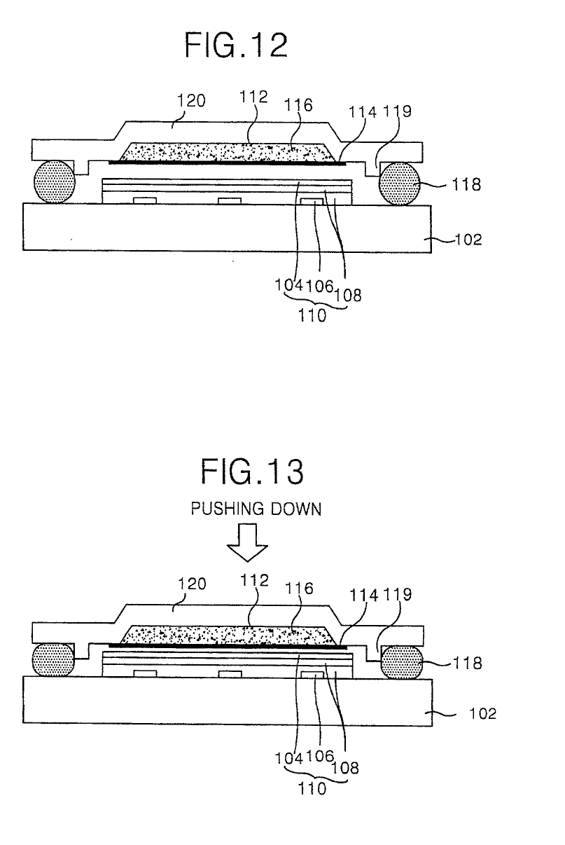

Referring to FIG. 12, an organic electroluminescent device according to a fourth embodiment of the present invention includes a substrate 102, an EL structure 110 formed on the substrate 102 and emitting light in accordance with a driving voltage and electric current supplied, and a packaging plate 120 adhered to the substrate 102 by an adhesive 118 to cover an EL structure 110 and having a diffusion preventing projected portion 119 for preventing the adhesive 118 from being diffused.

The EL structure 110 includes a first electrode 106 and a second electrode 104 formed on the substrate 102, and an organic compound layer 108 deposited between the first electrode 106 and the second electrode 104. At least one of the first electrode 106 and the second electrode 104 should be transparent to radiate the emitted light to the outside.

The organic compound layer 108 includes a single and multi layer thin film that transfers electrons and holes supplied from the first electrode 106 and the second electrode 104, or recombines them to generate excitons and to emit light. In this way, electrons and holes are supplied from the first electrode 106 and the second electrode 104 to the organic compound layer 108 to be recombined such that the EL structure 110 emits light.

Using the adhesive 118, the packaging plate 120 covers the first electrode 106, the second electrode 104, and the organic compound layer 108 formed on the substrate 102 for preventing the EL structure 110 from being degraded by moisture and/or oxygen in the atmosphere. Inert gas is injected into the space formed by joining the substrate 102 to the packaging plate 120. The packaging plate 120 emits the heat generated by the light-emission of the EL display and protects the EL structure 110 from the external forces as well as moisture and/or oxygen in the atmosphere.

For this, the packaging plate 120 includes a recess portion 112 formed at the central portion for containing an absorbent 116, a semi-permeable membrane 114 for supporting the absorbent 116, and a diffusion preventing projected portion 119 for shutting off the diffusion of the adhesive 118. The recess portion 112 is formed by convexly bending a flat plate at the area where it faces the EL structure 110 for containing the absorbent 116. Material such as BaO, CaO, or the like is contained in the internal space of the recess portion 112 for absorbing moisture and/or oxygen. Because the absorbent 116 is a powder, the semi-permeable membrane 114 is adhered to the rear of the concave portion 112 to pass moisture and/or oxygen, but prevents the absorbent 116 from falling onto the EL structure 110. Material such as Teflon, polyester, paper or the like may be used as the semi-permeable membrane 114.

The diffusion preventing projected portion 119 is projected with a fixed height between the central portion of the packaging plate 120 and the adhesive 118 to be formed. The diffusion preventing projected portion 119 prevents the adhesive 118 from being diffused to the EL structure 110 when combining the substrate 102 and the packaging plate 120.

As shown in FIG. 13, the substrate 102 and the packaging plate 120 are combined and sealed using the adhesive 118. For this, the adhesive 118 is preferably formed of a material such as epoxy, ultraviolet-setting resin, or a low melting metal. After being spread at the edge of the packaging plate 120, the adhesive adheres the substrate 102 to the packaging plate 120 by a fixed pressure in an inert gas atmosphere. The adhesive 118 spreads in accordance with the pressure pushing down upon the packaging plate 120, as well as the quantity and viscosity of the spread adhesive. The adhesive 118 diffused toward the EL structure 110 is prevented from being diffused beyond the diffusion preventing projected portion 119. Accordingly, because the diffusion preventing projected portion 119 prevents the adhesive 118 from being diffused to the EL structure 110, degradation of the EL structure 110 is prevented.

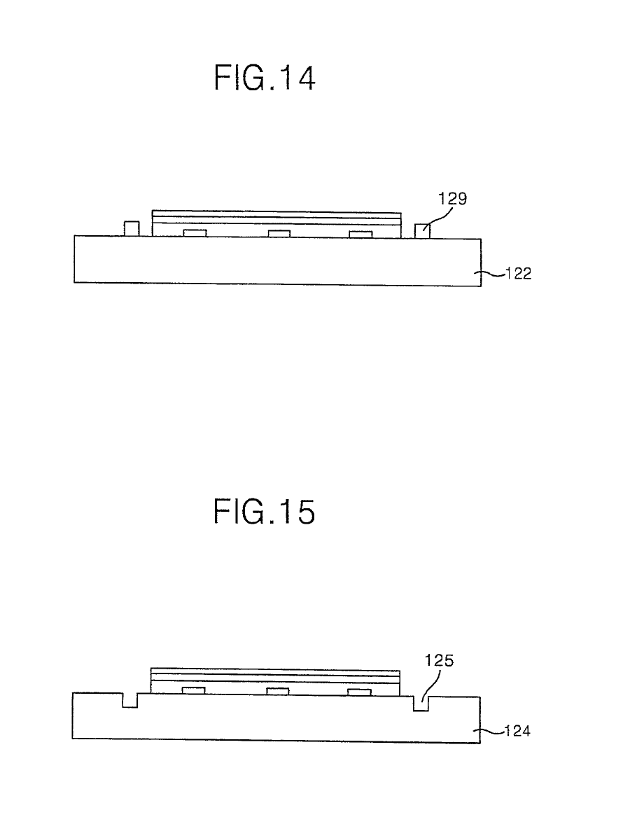

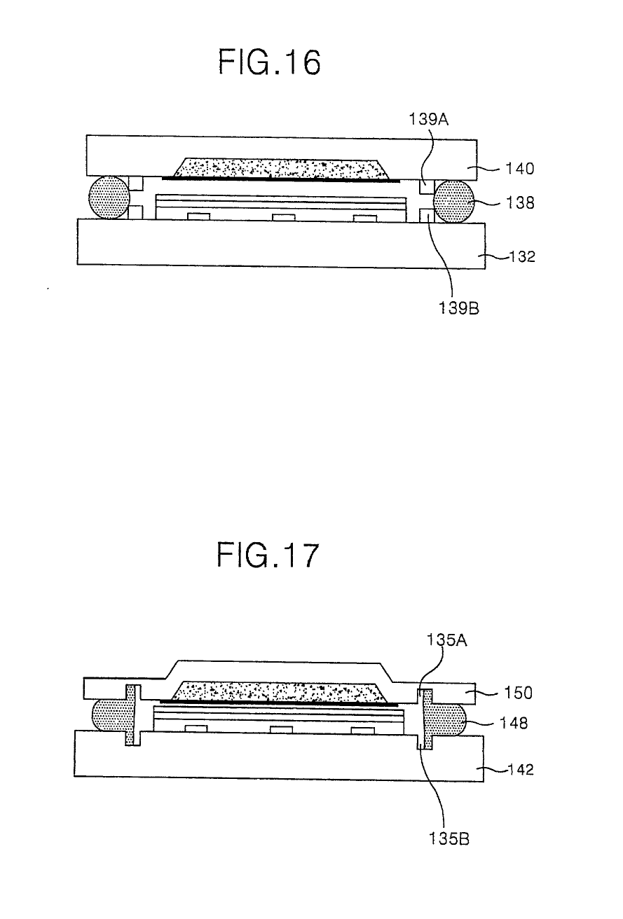

The diffusion preventing projected portion 129 and the diffusion preventing groove 125 for preventing the diffusion of the adhesive in this way, can be formed on the substrates 122 and 124 respectively as shown in FIGS. 14 and 15. Also, the diffusion preventing projected portions 139A and 139B and the diffusion preventing grooves 135A and 135B for preventing the diffusion of the adhesives 138 and 148 may be formed on the packaging plate 140 and 150 and the substrates 132 and 142 respectively as shown in FIGS. 16 and 17.

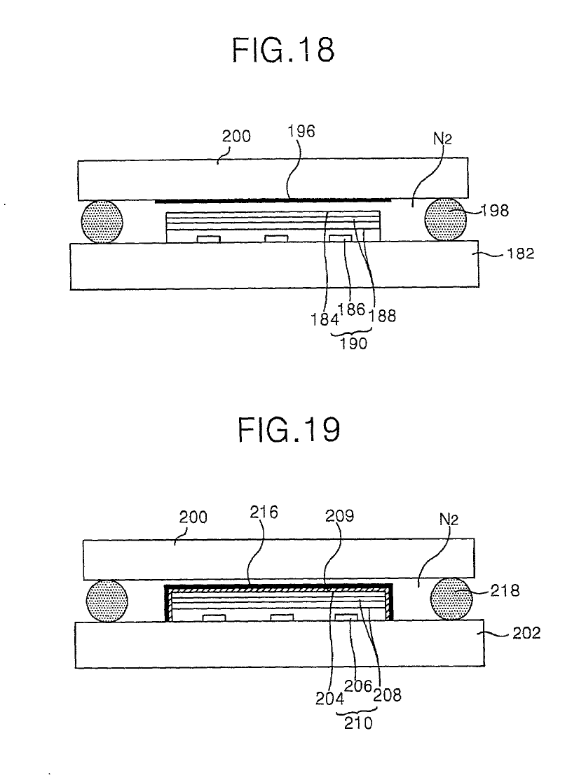

FIG. 18 is a sectional view representing an organic electroluminescent device according to a fifth embodiment of the present invention. Referring to FIG. 18, the organic electroluminescent device includes a substrate 182, an EL structure 190 formed on the substrate 182 for emitting light in accordance with a driving voltage and electric current supplied, a packaging plate 200 adhered to the substrate 182 by an adhesive 182 to cover the EL structure 190, and an absorbent film or membrane 196 formed on the rear of the packaging plate 200 for protecting the EL structure 190 from oxygen and/or moisture.

The EL structure 190 includes a first electrode 186 and a second electrode 184 formed on the substrate 182, as well as an organic compound layer 188 deposited between the first electrode 186 and the second electrode 184. The EL structure 190 emits light when electrons and holes are supplied from the first electrode 186 and the second electrode 184 to the organic compound layer 188 and recombined.

The packaging plate 200 is preferably formed using a flat glass plate, a metal plate or a plastic plate. The packaging plate 200 protects the EL structure 190 from external forces while transmitting heat generated when emitting light.

In FIG. 18, the absorbent film 196 is formed on the rear of the packaging plate 200 facing the EL structure 190. Absorbent material used for the absorbent film 196 is preferably one of an alkaline metal oxide (BaO, CaO, etc.), a Group II-Group VI compound (CaS, SrS, ZnS, or the like), an alkaline metal (Ca, Cs, etc.), and a getter alloy (ZrAl or any other alloy having absorbing properties). The absorbent material is selected to have a strong characteristic of absorbing oxygen and/or moisture in the air. In addition, the absorbent film 196 may be a thin film or a thick film formed by a physical vapor deposition method (such as evaporation, sputtering, etc.), or by a chemical vapor deposition, etc. The absorbent film 196 preferably has a wider area than the EL structure 190. Its thickness is thinner than a gap between the EL structure 190 and the packaging plate 200 when the substrate 182 and the packaging plate 200 are joined. Normally, the absorbent film 196 has a thickness of about 1˜100 μm (micrometers) because a gap between the EL structure 190 and the packaging plate 200 is about 100 μm (micrometers).

The packaging plate 200 where the absorbent film 196 is formed is transferred to a vacuum chamber (not shown) where the density of moisture and oxygen is controlled not to be exposed to the air. The packaging plate 200 seals the light emission area including the EL structure 190 by being adhered to the substrate 182 by the sealant 182. In this way, the organic electroluminescent device has the absorbent film 196 formed with absorbent materials for absorbing the oxygen and/or moisture in the air, thereby preventing the EL structure 190 from being degraded by oxygen and/or moisture.

FIG. 19 is a sectional view representing an organic electroluminescent device according to a sixth embodiment of the present invention. Referring to FIG. 19, an organic electroluminescent device includes a substrate 202, an EL structure 210 formed on the substrate 202 for emitting light in accordance with a driving voltage and electric current supplied, a packaging plate 220 adhered to the substrate 202 by an adhesive 218 in the manner of covering an EL structure 210, and an absorbent film 216 formed to surround the EL structure 210 for protecting the EL structure 210 from oxygen and/or moisture.

The packaging plate 220 is preferably formed using a glass plate, a metal plate or a plastic plate. The packaging plate 220 protects the EL structure 210 from external forces and transmit heat generated when emitting light to the outside. The EL structure 210 includes a first electrode 206 and a second electrode 204 formed on the substrate 202 as well as an organic compound layer 208 deposited between the first electrode 206 and the second electrode 204. The EL structure 210 emits light when electrons and holes are supplied from the first electrode 206 and the second electrode 204 to the organic compound layer 208 and recombined.

The absorbent film 216 is formed as a thin film or a thick film on the EL structure 210 facing the packaging plate 220. To prevent that the absorbent material of the absorbent film 216 from reacting with the organic compound layer 208 and damaging to the EL structure 210 when forming the film 216, a protective film 209 is formed between the EL structure 210 and the absorbent film 216. The protective film 209 is preferably made of one of an organic compound such as a polyacrl, polyimide or an inorganic compound such as silicon oxide, silicon nitride and aluminum oxide having a low reactivity.

Absorbent material used for the moisture absorbent film 216 is preferably one of an alkaline metal oxide, a Group II-Group VI compound, an alkaline metal, and a getter alloy. Such a moisture absorbent film 216 is formed on the protective film 209 by a physical vapor deposition method such as deposition, sputtering, or the chemical vapor deposition, etc.

The thickness of the moisture absorbent film 216 is preferably thinner than a gap between the EL structure 210 and the packaging plate 220 when the substrate 202 and the packaging plate 220 are joined. Normally, the moisture absorbent film 216 has a thickness of about 1˜100 μm (micrometers) since a gap between the EL structure 210 and the packaging plate 220 is about 100 μm (micrometers).

The substrate 202 where the moisture absorbent film 216 is formed on the EL structure 210 is transferred to a vacuum chamber (not shown) where the density of moisture and/or oxygen is controlled so as not to be exposed to the air. The substrate 202 and packaging plate 220 seal the light emission area including the EL structure 210 when sealed with the sealant 218.

In this way, the organic electroluminescent device has the absorbent film 216 formed with moisture absorbent material for absorbing oxygen and/or moisture in the air, thereby preventing the EL structure 210 from being degraded by oxygen and/or moisture.

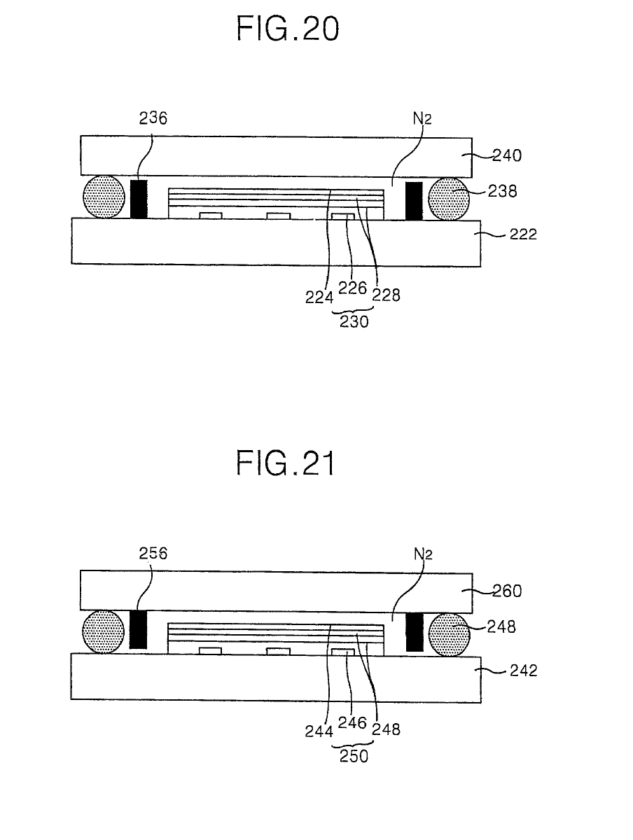

FIG. 20 is a sectional view representing an organic electroluminescent device according to a seventh embodiment of the present invention. Referring to FIG. 20, an organic electroluminescent device according to a seventh embodiment of the present invention includes a substrate 222, an EL structure 230 formed on the substrate 222 for emitting light in accordance with a driving voltage and electric current supplied, a packaging plate 240 adhered to the substrate 222 by an adhesive 238 to cover the EL structure 230, and an absorbent film 236 formed between the adhesive 238 and the EL structure 230 formed on the substrate 222 for protecting the EL structure 230 from oxygen and/or moisture.

The packaging plate 240 is preferably formed flat using a glass plate, a metal plate or a plastic plate. The packaging plate 240 protects the EL structure 230 from external forces and emits the heat generated when emitting light. The EL structure 230 includes a first electrode 226 and a second electrode 224 formed on the substrate 222, and an organic compound layer 228 deposited between the first electrode 226 and the second electrode 224. The EL structure 230 emits light when electrons and holes are supplied from the first electrode 226 and the second electrode 224 to the organic compound layer 228 and recombined.

The absorbent film 236 is formed as a thin film or a thick film on the substrate 222 between the adhesive 238 and the EL structure 230. Absorbent material used for the moisture absorbent membrane 236 is preferably one of alkaline metal oxide, a Group II-Group VI compound, an alkaline metal, and a getter alloy. The absorbent film 236 may be formed by a physical vapor deposition method such as deposition, sputtering, etc, or a chemical vapor deposition, etc.

The substrate 222 having the absorbent film 236 formed thereon is transferred to a vacuum chamber (not shown) where the density of moisture and oxygen is controlled not to be exposed to the air. The substrate 222 and packaging plate 240 seals the light emission area including the EL structure 230 using the sealant 238. Also, the absorbent film 236 can be used to maintain the gap between the packaging plate 240 and the substrate 222 during adhesion with the adhesive 238.

In this way, the organic electroluminescent device has the absorbent film 236 formed with absorbent materials for absorbing the oxygen and moisture in the air, thereby preventing the EL structure 230 from being degraded by oxygen and/or moisture.

FIG. 21 is a sectional view representing an organic electroluminescent device according to an eighth embodiment of the present invention. Referring to FIG. 21, an organic electroluminescent device according to a eighth embodiment of the present invention includes a substrate 242, an EL structure 250 formed on the substrate 242 for emitting light in accordance with a driving voltage and electric current supplied, a packaging plate 260 adhered to the substrate 242 by an adhesive 248 to cover the EL structure 250, and an absorbent film 256 formed on the rear of the packaging plate 260 for protecting the EL structure 250 from oxygen and/or moisture.

The packaging plate 260 preferably is formed flat using a glass plate, a metal plate and a plastic plate. The packaging plate 260 protects the EL structure 250 from external forces and emits the heat generated by the light emission process. The EL structure 250 includes a first electrode 246 and a second electrode 244 formed on the substrate 242, and an organic compound layer 248 deposited between the first electrode 246 and the second electrode 244. The EL structure 250 emits light when electrons and holes are supplied from the first electrode 246 and the second electrode 244 to the organic compound layer 248 and recombined.

The absorbent film 256 is formed as a thin film or a thick film on the rear of the packaging plate 260 between the adhesive 248 and the EL structure 250 formed on the substrate 242. Absorbent material used for the absorbent film 256 is preferably one of an alkaline metal oxide, a Group II-Group VI compound, an alkaline metal, and a getter alloy. The absorbent film 256 is preferably formed by a physical vapor deposition method such as deposition, sputtering, etc, or a chemical vapor deposition, etc.

The packaging plate 260 having the absorbent film 256 thereon is transferred to a vacuum chamber (not shown) where density of moisture and oxygen is controlled not to be exposed to the air. The packaging plate 260 and the substrate 242 seal the light emission area including the EL structure 250 by being adhered together by the sealant 248. Also, the absorbent film 256 can be used to maintain a gap between the packaging plate 260 and the substrate 242 during adhesion. In this way, the organic electroluminescent device has the absorbent film membrane 256 formed with absorbent materials for absorbing oxygen and/or moisture in the air, thereby preventing the EL structure 250 from be degraded by oxygen and/or moisture.

Thus, the electroluminescent device according to the fifth through eighth embodiments of the present invention forms the moisture absorbent membrane as a film instead of a powder, thereby preventing a possible contamination occurring when mounting the absorbent material in powder. It has also an advantage in packaging a large-scale element according to the trend to the large-scale. Of course, the the electroluminescent device may include a diffusion preventing portion and the packaging plate need not be a flat plate.

As described above, the organic electroluminescent device according to the embodiments of the present invention forms the groove and/or projected portion to prevent the adhesive from diffusing into the EL structure, thereby preventing the degradation of the EL structure structure caused by the adhesive. Also, the electroluminescent device according to the embodiments of the present invention does not require forming the packaging plate for mounting the moisture absorbent material as powder by forming an absorbent film on the packaging plate, the EL structure, or the substrate. Also, the electroluminescent device according to the embodiments of the present invention has an advantage of reducing the thickness and weight of the whole panel because a semi-permeable membrane or a process for joining it is not required. Of course, it should be recognized that the embodiments can be combined or modified with respect to each other.

It will be apparent to those skilled in the art that various modifications and variations can be made in the organic electroluminescent device of the present invention without departing from the spirit or scope of the invention. Thus, it is intended that the present invention cover the modifications and variations of this invention provided that they come within the scope of the appended claims and their equivalents.

What is claimed is:

1. An organic electroluminescent device, comprising:
a substrate;
an organic electroluminescent portion formed on the substrate;
a packaging plate joined with the substrate to cover the organic electroluminescent portion;
a sealant disposed between the substrate and the packaging plate to join the substrate with the packaging plate; and
a diffusion preventing portion disposed on at least one of the packaging plate and the substrate to prevent the sealant from contacting the organic electroluminescent portion.

2. The organic electroluminescent device according to claim 1, wherein the diffusion preventing portion includes at least one groove formed on at least one of the substrate and the packaging plate.

3. The organic electroluminescent device according to claim 2, wherein the at least one groove is formed between the organic electroluminescent portion formed on the substrate and the sealant.

4. The organic electroluminescent device according to claim 2, wherein grooves are formed on both the substrate and the packaging plate.

5. The organic electroluminescent device according to claim 2, wherein the at least one groove is formed with a fixed width and depth.

6. The organic electroluminescent device according to claim 1, wherein the diffusion preventing portion includes at least one projection formed on at least one of the substrate and the packaging plate.

7. The organic electroluminescent device according to claim 6, wherein the at least one projection is formed between the organic electroluminescent portion formed on the substrate and the sealant.

8. The organic electroluminescent device according to claim 6, wherein the diffusion preventing portion includes projections formed on both the substrate and the packaging plate.

9. The organic electroluminescent device according to claim 6, wherein the at least one projection is formed with a fixed height.

10. The organic electroluminescent device according to claim 1, wherein the packaging plate includes:
a plate member defining a recess portion formed at a central portion of the plate member on a surface of the plate member disposed toward the substrate;
an absorbent material disposed in the recess portion for absorbing at least one of oxygen and moisture; and
a semi-permeable membrane adhered to the plate member to enclose the absorbent material in the recess portion.

11. The organic electroluminescent device according to claim 10, wherein the plate member is configured as a substantially thin flat plate with a groove cut therein to define the recess portion.

12. The organic electroluminescent device according to claim 10, wherein the plate member is configured as a convexly bent plate to define the recess portion.

13. An organic electroluminescent device, comprising:
a substrate;
an organic electroluminescent portion formed on the substrate;
a packaging plate to protect the organic electroluminescent portion from moisture and oxygen and from external forces;
a moisture absorbent film disposed on at least one of the substrate, the packaging plate, and the organic electroluminescent layer; and
a sealant disposed between the substrate and the packaging plate to join the substrate with the packaging plate.

14. The organic electroluminescent device according to claim 13, wherein the moisture absorbent film is formed with a thickness less than 100 μm (micrometers).

15. The organic electroluminescent device according to claim 13, wherein the packaging plate is made of at least one of glass, metal and plastic.

16. The organic electroluminescent device according to claim 13, wherein the moisture absorbent film includes at least one of alkaline metal oxide, a Group II-Group VI compound, an alkaline metal and a getter alloy.

17. The organic electroluminescent device according to claim 13, wherein the moisture absorbent film is formed on one of the substrate and the packaging plate between the sealant and the organic electroluminescent portion.

18. The organic electroluminescent device according to claim 13, wherein the moisture absorbent film is formed on the organic electroluminescent portion on at least a surface thereof disposed toward the packaging plate.

19. The organic electroluminescent device according to claim 18, further comprising a protective film disposed between the moisture absorbent film and the surface of the electroluminescent portion to prevent the moisture absorbent film and the organic electroluminescent portion from directly contacting each other.

20. The organic electroluminescent device according to claim 19, wherein the protective film includes at least one of an organic compound and an inorganic compound, the organic compound including at least one of a polyacryl and a polyimide, and the inorganic compound including at least one of silicon oxide, silicon nitride and aluminum oxide.

21. The organic electroluminescent device according to claim 13, wherein the moisture absorbent film is disposed on a surface of the packaging plate toward the organic electroluminescent portion.

22. The organic electroluminescent device according to claim 13, wherein the moisture absorbent film is formed as thick film of a deposition method.

23. The organic electroluminescent device according to claim 13, wherein the moisture absorbent film has its thickness less than a distance between the organic electroluminescent portion and the packaging plate.
